(19) United States
(12) Patent Application Publication
(10) Pub. No.: US 2015/0141315 A1
(43) Pub. Date: May 21, 2015

(54) Method to recover or increase water absorbency of polyester textile

(71) Applicant: Dawei Jin, Shanghai (CN)

(72) Inventor: Dawei Jin, Shanghai (CN)

(73) Assignee: RHODIA OPERATIONS, Paris (FR)

(21) Appl. No.: 14/407,077

(22) PCT Filed: Jun. 15, 2012
(86) PCT No.: PCT/CN2012/076999

§ 371 Date: Dec. 11, 2014

(51) Int. Cl. C11D 11/00; C11D 3/30; C11D 3/00; C11D 3/37

(52) U.S. Cl. CPC C11D 11/0017; C11D 3/3715; C11D 3/30; C11D 3/001; C11D 3/0036
USPC 510/299

(57) ABSTRACT

The present invention concerns then a method to recover or increase the water absorbency of a polyester textile, wherein a composition comprising at least a polyester soil release polymer and a quaternary ammonium softener is used to wash and/or rinse said polyester textile. This composition of the invention may be perfectly used during the water cycle(s) of the laundry or in the rinse cycle(s), notably used in the final rinse. The invention concerns as well a softener composition, notably used in the rinsing cycles of the laundry, comprising a polyester soil release polymer and a quaternary ammonium softener.

### CROSS-REFERENCE TO RELATED APPLICATIONS

The present application is a U.S. national stage entry under 35 U.S.C. §371 of International Application No. PCT/CN2012/076999 filed Jun. 15, 2012, the whole content of this application being herein incorporated by reference for all purposes.

### FIELD OF THE INVENTION

The present invention concerns then a method to recover or increase the water absorbency of a polyester textile, wherein a composition comprising at least a polyester soil release polymer and a quaternary ammonium softener is used to wash and/or rinse said polyester textile. This composition of the invention may be perfectly used during the water cycle(s) of the laundry or in the rinse cycle(s), notably used in the final rinse. The invention concerns as well a softener composition, notably used in the rinsing cycles of the laundry, comprising a polyester soil release polymer and a quaternary ammonium softener.

### BACKGROUND OF THE INVENTION

Several textile properties would influence the thermal comfort of a garment or towel, such as water absorbency, water vapor transmission, air permeability, and heat transfer. For example, when the wearer is active, it is very important for the textile to have the ability to absorb moisture from the skin. Whenever fibers absorb liquid water or moisture vapor, heat is released, and therefore, water absorbency of fabrics is an important factor that affects the wearer's thermal comfort. The ability of a fabric to carry away water/moisture to maximize the evaporation of liquid moisture contributes to the thermal comfort of a garment, especially for sportswear.

Synthetic fibers, such as polyester, nylon, and acrylic, have very low moisture regain, and it exists several ways, notably of finishing and treatment to obtain a better body moisture management and increase the moisture wicking phenomena. The main known is to apply a topical treatment to a textile, such as a garment, made from hydrophobic fibers, such as polyester, to give it the ability to absorb sweat. The hydrophilic finish or treatment will allow this type of textile to absorb residue, while its hydrophobic (water-hating) fibers will help it to dry fast, keeping the wearer more comfortable.

It is also known that static charges may accumulate on polyesters textile fabrics, resulting in clinging and crackling. Fabric softeners are then usually employed to act as anti-static agents by enabling synthetic fibers to retain sufficient moisture to dissipate static charges.

Fabric softeners tend to be based on quaternary ammonium salts with one or two long alkyl chains, a typical compound being dipalmitoylethyl hydroxyethylmonium methosulfate. Other cationic compounds can be derived from imidazolium, substituted amine salts, or quaternary alkoxy ammonium salts. One of the most common compounds of the early formulations was dihydrogenated tallow dimethyl ammonium chloride (DHTDMAC). There are three main types of quaternary ammonium compounds used in the formulation of household fabric softeners: dialkyldimethyl ammonium compounds, diamido alkoxylated ammonium compounds, and imidazolinium compounds.

However, these fabric softeners have a high influence on water absorbency of polyester textile. Indeed, the repetitive use of fabric softeners during the laundering process may leave residue of softener on the fabrics, which may create a barrier to airflow and water vapor transmission of the coated fabric, leading to decrease the water absorbency of said polyester textiles, via a waterproof effect.

Because of the particular properties they hold, moisture management clothing requires some special care and it's always important, though it's a constraint and an inconvenience for end user, to check the care label, that gives specific instructions on washing and drying for such a clothing and mainly expressing to “do not use softener”.

There is then a need to carrying out a washing, cleaning and rising composition comprising softeners that could be used on moisture management clothing without decreasing the water absorbency of said textiles while avoiding the disadvantages known in the prior art.

### SUMMARY OF THE INVENTION

It appears now that it's perfectly possible to obtain a washing, cleaning and rising composition for polyester textiles that comprises softeners and would permit to recover or increase the hydrophilic ability of said polyester textiles and/or hydrophilic polyester textiles and then recover or augment the water absorbency of said textiles.

The present invention concerns then a method to recover or increase the water absorbency of a polyester textile, wherein a composition comprising at least a polyester soil release polymer and a quaternary ammonium softener is used to wash and/or rinse said polyester textile.

Increasing of the water absorbency of polyester textiles may notably mean to increase water absorbency of said textiles in comparison with the water absorbency of these textiles after a classical use of a rinsing cycle, in the laundry treatment, that comprises or does not comprise the use of softener. Recovering of the water absorbency of polyester textiles may notably mean to recover or regain water absorbency of said textiles in comparison with the water absorbency of these textiles after a classical use of a rinsing cycle, in the laundry treatment, that comprises the use of softener.

The invention also concerns the use of a composition comprising at least a polyester soil release polymer and a quaternary ammonium softener to recover or increase the water absorbency of a polyester textile. The present invention also recites the use of a composition comprising at least a polyester soil release polymer and a quaternary ammonium softener to recover or increase the hydrophilic ability from a polyester textile.

The invention concerns as well a softener composition, notably used in the rinsing cycles of the laundry, comprising a polyester soil release polymer and a quaternary ammonium softener.

Such an effect can be used by a synergistic blend of a polyester soil release polymer and a quaternary ammonium softener. The composition of the present inventions indeed permits to recover or increase water absorbency of polyester textiles contrary to it could have been suspected by the knowledge of the prior art in the field of laundry. This composition also permits to obtain a good level of soil release properties and anti-static properties.

This composition of the invention may be perfectly used during the water cycle(s) of the laundry or in the rinse cycle(s), notably used in the final rinse.

### DETAILED DESCRIPTION OF THE INVENTION

Polyester textiles are fabric textiles made of at least polyester yarns, thread and/or fibers. A textile or cloth is a flexible woven or non-woven material consisting of a network of natural or artificial fibres often referred to as thread or yarn. Textiles are usually formed by weaving, knitting, crocheting, knotting, or pressing fibres together (felt). Polyester fibres is used in all types of clothing, either alone or blended with other fibres, such as cotton.

Yarns, thread and/or fibers may have usual circular cross-sections or non-circular cross-section, such as for example multilobal (trilobal, pentalobal), hexagonal or irregular shapes. Yarns, thread and/or fibers may have a hollow shapes, for example produced with plug-in-orifice spinnerets, tube-in-orifice spinnerets or segment-arc spinnerets. In a specific embodiment, polyester textiles comprise yarns, thread and/or fibers having a non-circular cross-section.

According to an embodiment of the present invention, polyester textile may provide a hydrophilic finish or treatment. Hydrophilic finish or treatment relies on the chemical and molecular properties of water molecules. Hydrophilic finishes usually compensate for lower moisture and water absorption capacity in synthetic fiber materials.

Hydrophilic polyester textiles providing a hydrophilic finish or treatment may be obtained by several methods known in the prior art.

One of the main methods is to provide a hydrophilic compound to the yarns, threads or fibers, on themselves and/or on the final textile fabric. Hydrophilic compound may be applied by a dipping or a spraying method.

Hydrophilic compound may be for example a compound of formula R—O—(CH₂CH₂O)ₙH, wherein R is a C₁₂ to C₁₈ alkyl group and n may be between 7 and 25.

Hydrophilic compound may be for example a formulation containing a mixture of an alkoxylated ricinoleic acid derivative, a hydrogenated ricinoleic acid derivative, a C₁₈ fatty acid and a polyalkoxylated polymethyl siloxane, as described on U.S. Pat. No. 5,045,387. Hydrophilic compound may also be for example a formulation containing a fatty acid diethanolamide, a polyether-modified silicone, a sorbitan fatty acid ester and a metal salt of an alkyl sulfonate, as described on EP372890.

It can also be possible to provide a coating of a water-base or solvent polymer resin, such as for example polyacrylamide or polyurethane resins. The skilled artisan will select monomers and/or oligomers that provide the desired level of hydrophilicity to the coating. Polymer resins may comprises oligomer and/or monomer components including hydrophilic moieties in their structure, such as hydroxyl, polyether especially poly (ethylene glycol), polyester, amide, amine, carboxylic acid, sulfonate, phosphate, urethane, urea, polypeptide or polysaccharide moieties. For example, polyether-base, (especially poly (ethylene glycol)-based), polyester-based and hydroxyfunctional oligomers are especially desirable for use in a curable compositions used to make the coatings. Monomers such as poly (ethylene glycol) monoacrylate; poly (ethylene glycol) diacrylate; N vinyl-2-pyrrolidone; N, N-dimethylacrylamide; N-hydroxy succinimide; 2-hydroxyethyl acrylate; acrylic acid; acrylated phosphates, styryl sulfonates; and sorbitol acrylate are especially useful in formulating the curable compositions.

Hydrophilic compound can also be a polysaccharide, or a modified polysaccharide.

An other method is to provide a hydrophilic treatment on the yarns, threads or fibers, on themselves and/or on the final textile fabric, for example via a plasma treatment.

Polyester textiles of the invention may be as example garments such as sportswear clothes notably used into the range of winter sports or summer sports, in the sleepwear market, or various household linens such as towels.

Suitable soil release polymer is conventionally copolymers or terpolymers of terephthalic acid with ethylene glycol and/or propylene glycol units, notably in various arrangements. Examples of such polymers are disclosed in the commonly assigned U.S. Pat. No. 4,116,885 and 4711730 and EP0272033.

Especially effective polymeric soil release agents are the block copolymers of polyalkylene terephthalate and polyoxyethylene terephthalate, and the block copolymers of polyalkylene terephthalate and polyethylene glycol. The polyalkylene terephthalate block copolymers preferably comprise ethylene and/or propylene alkylene groups. Many of such soil release polymers are nonionic. More specifically, these polymers are comprised of repeating units of ethylene and/or propylene terephthalate and polyethylene oxide terephthalate, preferably at a molar ratio of ethylene terephthalate units to polyethylene oxide terephthalate units of from about 25:75 to about 35:65, said polyethylene oxide terephthalate containing polyethylene oxide blocks having molecular weights of from about 300 to about 2000. The molecular weight of these polymeric soil release agents is in the range of from about 4,000 to about 55,000. Other useful soil release polymers include, but are not limited to, polyester urethane, and acetic acid ethenyl esters; the polyethylene terephthalate/polyoxyethylene terephthalate (PET-POET) polymer being most preferable. Typically, molecular weight ranges of these polymers are from 500 to 120,000, preferably 2000 to 35,000 and most preferably 2000 to 25,000.

Another preferred polymeric soil release agent is a crystallizable polyester with repeat units of ethylene terephthalate containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials Zelcon 4780 (from DuPont) and Milease T (from ICI).

Such soil release polymers are described in U.S. Pat. No. 4,849,257, this patent being incorporated herein by reference. Another preferred nonionic soil release polymer is described in USSN 676682 from which the WO92/17523 claims priority.

The most preferred nonionic soil release agents are the REPEL-O-TEX line of soil release agents sold by Rhone-Poulenc Inc., Cranbury, N.J. These products include REPEL-O-TEX SRP3, REPEL-O-TEX SRP4, REPEL-O-TEX QCJ product and REPEL-O-TEX QCX products. VELVETOL 251C is a 100% active hydrophilic polyester from which REPEL-O-TEX SRP3, SRP4, AND QCJ are manufactured at different polymer concentrations. The polymers have a molecular weight of from about 3,000 to about 10,000. REPEL-O-TEX QCJ product is a 15 weight percent active dispersion of the above mentioned polymer for liquid laundry detergents, whereas SRP3 and SRP4 are diluted with sodium sulfate for powder detergent applications. The polymers of the REPEL-O-TEX products are nonionic polyester-polyether (PET-POET) transesterification co-polymers. The REPEL-O-TEX QCX is a higher molecular weight hydrophilic polyester polymer with a molecular weight range of from about 10,000 to about 35,000.

Polyester soil release polymer may be a polyether-polyester block copolymer. Preferably the polyether-polyester block copolymer is obtained with the following process:

(a) transesterification reaction of at least one di(C₁-C₄)alkyl ester of aromatic dicarboxylic acid and at least one aliphatic diol or aliphatic polyol in an inert solvent, wherein the inert solvent has a boiling point higher than the boiling point of the alcohol by-product of the transesterification reaction;
(b) polycondensation reaction of the product of step (a) and one or more selected from the group consisting of at least one polyether, at least one mono-alcohol, at least one mono-carboxylic acid and at least one ester, wherein the polyether has at least one terminal hydroxyl group.

This process is described in WO2011/000158.

In one more preferred embodiment of the present invention, the di(C₁-C₄)alkyl ester of aromatic dicarboxylic acid is dimethyl terephthalate; the aliphatic diol is one or more selected from the group consisting of ethylene glycol and 1,2-propylene glycol; and the polyether is one or more selected from the group consisting of MPEG of MW 750, PEG of MW 600, PEG of MW 1000, PEG of MW 1500, MPEG-b-PPG of MW 750, PPG-b-PEG-b-PPG of MW 1000 and PPG-b-PEG-b-PPG of MW 1500, where MPEG is methoxy polyethylene glycol, PEG is polyethylene glycol, PPG is polypropylene glycol.

Soil release polymer may be under the form of solid or liquid state.

The polyester soil release polymer is optionally present in an amount of from 0 to 50 wt %, preferably from 0 to 10 wt %, more preferably 0.1 to 5 wt %, based on the weight of the total composition.

Preferred quaternary ammonium softeners are water dispersible.

Most preferred quaternary ammonium softeners are those ones of the general formula (I):

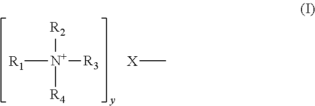

Wherein:
R¹, R², R³ and R⁴, which may be the same or different, is a C₁-C₃₀ hydrocarbon group, typically an alkyl, hydroxyalkyl or ethoxylated alkyl group, optionally interrupted with a heteroatom or an ester or amide group,
X is an anion, for example halide, as Cl or Br, sulphate, alkyl sulphate or acetate,
y is the valence of X.

Quaternary ammonium softeners are more preferably alkyl quat, such as dialkyl quat, or ester quat such as a dialkyl diester quat.

Dialkyl quat may be a compound of formula general (II):

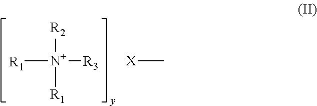

Wherein:
R¹ is an aliphatic C₁₆₋₂₂ hydrocarbon group,
R² is a C₁-C₃ alkyl group,
R³ is R¹ or R²,
X is an anion, for example halide, as Cl or Br, sulphate, alkyl sulphate or acetate,
y is the valence of X.

Dialkyl quat is preferably di-(hardened tallow) dimethyl ammonium chloride.

In a preferred embodiment, quaternary ammonium softeners are compounds of formula (III):

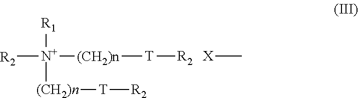

Wherein:
R¹ group is independently selected from C₁-C₄ alkyl group
R² group is independently selected from C₁-C₃₀ alkyl or alkenyl group
T is —C(═O)—O—
n is an integer from 0 to 5
X is an anion, for example a chloride, bromide or methosulphate ion.

Particularly preferred quaternary ammonium fabric softening materials comprise two C₁₂₋₂₈ alkyl or alkenyl groups connected to the nitrogen head group, preferably via at least one ester link. It is more preferred if the quaternary ammonium material has two ester links present.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear, although a degree of branching, especially mid-chain branching, is within the scope of the invention.

Ester quaternary ammonium compounds may be for example triethanolamine-based quaternary ammonium of formula (IV):

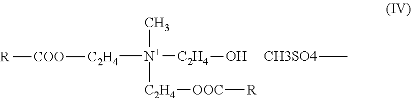

Wherein R is a C₁₂-C₂₀ alkyl chain.

Preferred quaternary ammonium softeners of the present invention are:

TET: Di(tallowcarboxyethyl)hydroxyethyl methyl ammonium methylsulfate
TEO: Di(oleocarboxyethyl)hydroxyethyl methyl ammonium methylsulfate,
TES: Distearyl hydroxyethyl methyl ammonium methylsulfate,
TEHT: Di(hydrogenated tallow-carboxyethyl)hydroxyethyl methyl ammonium methylsulfate,
TEP: Di(palmiticcarboxyethyl)hydroxyethyl methyl ammonium methylsulfate,

The quaternary ammonium softeners is optionally present in an amount of from 0.1 to 50 wt %, preferably from 1 to 25 wt %, more preferably 3 to 20 wt %, based on the weight of the total composition.

In said composition the weight ratio between soil release polymer and quaternary ammonium softener (soil release polymer/quaternary ammonium softener) may be comprised between 0.0001 and 10, preferably between 0.005 and 1, more preferably between 0.01 and 0.5.

Composition of the invention may also comprises classical additives used in the laundry compositions, such as detergent, dye transfer inhibiting agents, surfactants, bleaches, enzymes, perfumes, preservatives, biocides, viscosity control agents, grease removal agents, soil release agents, builders, sequestrants, optical brighteners, pH regulators, etc.

The compositions of the invention may be of any suitable physical form, for example, particulates, such as powders, granules, or tablets, liquids, pastes, gels or bars. According to one especially preferred embodiment of the invention, the composition is in particulate form, preferably powder form. The composition can be formulated for use as hand wash or machine wash composition.

The compositions of the invention may be prepared by any suitable process. As example, a fabric softener composition may be prepared by conventional methods such as those disclosed in U.S. Pat. No. 5,402,542. Powders of low to moderate bulk density may be prepared by spray-drying a slurry, and optionally postdosing (dry-mixing) further ingredients. “Concentrated” or “compact” powders may be prepared by mixing and granulating processes, for example, using a high-speed mixer/granulator, or other non-tower processes. Tablets may be prepared by compacting powders, especially “concentrated” powders. Liquid compositions may be prepared by admixing the essential and optional ingredients in any desired order to provide compositions containing the ingredients in the requisite concentrations. The choice of processing route may be in part dictated by the stability or heat-sensitivity of the surfactants involved, and the form in which they are available.

The additives and ingredients that are described in this document can be introduced either way; either they are separately added in the slurry, either they are added separately in the post-addition. Preferably, as some of the soil release polymers have a waxy character at room temperature and are not easy to make into powder, the slurry route will be chosen.

The invention also relates to a process washing, cleaning or rinsing textiles involving diluting the composition of the invention. This process can be carried out in a domestic private context, or in an industrial, institutional or service context.

The invention will now be further illustrated by the following non limiting examples.

### EXPERIMENTS

The following products are used in the following examples:
Liquid detergent formulation: same as used in the experimental part of US20060073994
Ester quat: TEP: Di(palmiticcarboxyethyl)hydroxyethyl methyl ammonium methylsulfate; Fentacare TEP softener from Rhodia
Dialkyl quat softerner: Distearic dimethyl ammonium chloride from TCI
Crystal Repel-O-Tex® from Rhodia. Polyether-polyester block copolymer according to WO2011/000158

2 kinds of fabrics are used in the trials:
Polyester fabric with a hydrophilic coating: PET Fabric as described in EP2314176 with a high degree of moisture wicking
Polyester fabric made of non round fibers: PET fibers which has a multi-grooved scalloped-oval cross-section as mentioned in U.S. Pat. No. 5,817,740.

### Softener Compositions

The softener compositions of the invention comprise water and 5 wt % of ester quat or dialkyl quat solution and/or 0.5 wt % of Crystal Repel-O-Tex®.

### Procedure of Treatment

3 wash cycles of polyester fabrics were made, each cycle is the following:
Wash with liquid detergent formulation for 20 minutes, pH=7 at 0.1% dosage level −1 g/L. All the experiment are operated at 20° C.
Rinse with water for 5 minutes
Rinse with softener composition for 5 minutes
Dry in line

### Vertical Wicking Test/Standard Migration Test Procedure

Vertical wicking of the fabrics has been determined by measuring the wicking height against gravity along the warp and weft direction of the fabric. The test has been conducted using a vertical wicking tester according to DIN 53924 method. A strip of fabric (200 mm×25 mm) was suspended vertically with its lower end (30 mm) immersed in a reservoir of distilled water, to which 1% reactive dye (Prussian blue) was added for tracking the movement of water and at a regular time interval, the height reached by water in the fabric was measured with respect to the clamped scale by capturing images at regular interval by a fixed camera.

### Results

On polyester fabric with a hydrophilic coating, results are mentioned in Table 1:

TABLE 1

| | Wicking Height |
|---|---|
| Softener composition | (cm/10 min.) |
| None (water) | 35 |
| Ester quat softener | 100 |
| Crystal Repel-O-Tex ® | 130 |
| Ester quat + Crystal Repel-O-Tex ® | 160 |
| Dialkyl quat + Crystal Repel-O-Tex ® | 115 |

It appears then that the composition of the present invention comprising a polyester soil release polymer and a quaternary ammonium softener permits to increase the water absorbency of a hydrophilic polyester textile providing a hydrophilic finish or treatment.

On polyester fabric made of non round fibers, results are mentioned in Table 2:

TABLE 2

| | Wicking Height |
|---|---|
| Softener composition | (cm/10 min.) |
| None (water) | 59 |
| Dialkyl softener | 0 |
| Dialkyl softener + Crystal Repel-O-Tex ® | 44 |
| Ester quat softener + Crystal Repel-O-Tex ® | 80 |

It appears then that the composition of the present invention comprising a polyester soil release polymer and a quaternary ammonium softener permits to recover the water absorbency of a polyester textile, notably to remove the loss of water absorbency induced by the softener alone.

1. A method to recover or increase the water absorbency of a polyester textile, wherein a composition comprising at least a polyester soil release polymer and a quaternary ammonium softener is used to wash and/or rinse said polyester textile.

2. The method according to claim 1, wherein said polyester textile comprises yarns, thread and/or fibers having non-circular cross-section.

3. The method according to claim 1, wherein said polyester textile provides a hydrophilic finish or treatment.

4. The method according to claim 1, wherein said polyester soil release polymer is a copolymer or terpolymer of terephthalic acid with ethylene glycol and/or propylene glycol units.

5. The method according to claim 1, wherein said polyester soil release polymer is a block copolymer of polyalkylene terephthalate and polyoxyethylene terephthalate, and the block copolymers of polyalkylene terephthalate and polyethylene glycol.

6. The method according to claim 1, wherein said polyester soil release polymer is a polyether-polyester block copolymer obtained with the following process:
(a) transesterification reaction of at least one di(C₁-C₄)alkyl ester of aromatic dicarboxylic acid and at least one aliphatic diol or aliphatic polyol in an inert solvent, wherein the inert solvent has a boiling point higher than the boiling point of the alcohol by-product of the transesterification reaction;
(b) polycondensation reaction of the product of step (a) and one or more selected from the group consisting of at least one polyether, at least one mono-alcohol, at least one mono-carboxylic acid and at least one ester, wherein the polyether has at least one terminal hydroxyl group.

7. The method according to claim 1, wherein the quaternary ammonium softener corresponds to the general formula (I): 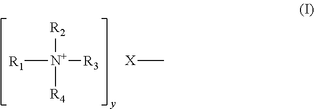
Wherein:
R¹, R², R³ and R⁴, which may be the same or different, is a C₁-C₃₀ hydrocarbon group, optionally interrupted with a heteroatom or an ester or amide group,
X is an anion,
y is the valence of X.

8. The method according to claim 1, wherein the quaternary ammonium softener corresponds to the general formula 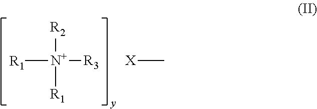
Wherein:
R¹ is an aliphatic C₁₆₋₂₂ hydrocarbon group,
R² is a C₁-C₃ alkyl group,
R³ is R¹ or R²,
X is an anion,
y is the valence of X.

9. The method according to claim 1, wherein the quaternary ammonium softener corresponds to the general formula (III): 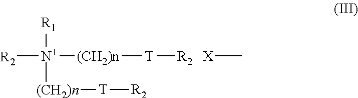
Wherein:
R¹ group is independently selected from C₁-C₄ alkyl group
R² group is independently selected from C₁-C₃₀ alkyl or alkenyl group
T is —C(═O)—O—
n is an integer from 0 to 5,
X is an anion.

10. The method according to claim 1, wherein the quaternary ammonium softener corresponds to the general formula (IV): 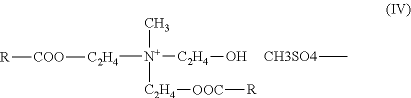
Wherein R is a C₁₂-C₂₀ alkyl chain.

11. The method according to claim 1, wherein the quaternary ammonium softener is selected from chosen in the group consisting of:
TET: Di(tallowcarboxyethyl)hydroxyethyl methyl ammonium methylsulfate
TEO: Di(oleocarboxyethyl)hydroxyethyl methyl ammonium methylsulfate,
TES: Distearyl hydroxyethyl methyl ammonium methylsulfate,
TEHT: Di(hydrogenated tallow-carboxyethyl)hydroxyethyl methyl ammonium methylsulfate, and
TEP: Di(palmiticcarboxyethyl)hydroxyethyl methyl ammonium methylsulfate,

12. The method according to claim 1, wherein the weight ratio between soil release polymer and quaternary ammonium softener is comprised between 0.0001 and 10.

13. A method to recover or increase the water absorbency of a polyester textile comprising a step of using a composition comprising at least a polyester soil release polymer and a quaternary ammonium softener.

14. A method to recover or increase the hydrophilic ability from a polyester textile comprising a step of using a composition comprising at least a polyester soil release polymer and a quaternary ammonium.

15. A softener composition for the rinsing cycles of the laundry, comprising a polyester soil release polymer and a quaternary ammonium softener.

16. A softener composition according to claim 15, wherein the weight ratio between soil release polymer and quaternary ammonium softener is comprised between 0.0001 and 10.
